(19) United States
(12) Patent Application Publication
(10) Pub. No.: US 2026/0331118 A1
(43) Pub. Date: Oct. 22, 2026

(54) WIND NOISE CANCELLATION USING DUAL-MICROPHONE COHERENCE ANALYSIS FOR ENHANCED AUDIO PERFORMANCE

(71) Applicant: Synaptics Incorporated, San Jose, CA (US)

(72) Inventors: Saeed Mosayyebpour Kaskari, Irvine, CA (US); Alireza Masnadi-Shirazi, Irvine, CA (US)

(73) Assignee: Synaptics Incorporated, San Jose, CA (US)

(21) Appl. No.: 19/174,687

(22) Filed: Apr. 9, 2025

(51) Int. Cl. G10L 21/0208; G10L 25/78

(52) U.S. Cl. CPC G10L 21/0208; G10L 25/78

(57) ABSTRACT

A method, device, and system for audio signal processing is related to detecting and cancelling wind noise in an audio signal. In the presence of wind noise the energies of the different microphones are uncorrelated. The coherence of audio signals from at least two microphones, accordingly, may be determined and used to detect the presence of wind noise. If wind noise is detected, the coherence of the audio signals may be used to filter the audio signal to cancel the wind noise from the audio signal. The filter may determine a non-stationary noise gain based on the coherence of the audio signals, and a stationary noise gain based at least partially on the non-stationary noise gain and may apply the non-stationary noise gain and the stationary noise gain to the audio signal to remove the wind noise.

### TECHNICAL FIELD

The present implementations relate generally to signal processing, and specifically to multi-channel noise reduction techniques.

### BACKGROUND OF RELATED ART

Many communication devices include microphones configured to convert sound waves into audio signals that can be transmitted, over a communications channel, to a receiving device. The audio signals often include a speech component (such as from a user of the communication device) and a noise component (such as from traffic, car, or wind noise). Speech enhancement is a signal processing technique that attempts to suppress the noise component of the received audio signals without distorting the speech component. Many existing speech enhancement techniques rely on statistical signal processing algorithms that continuously track the pattern of noise in each frame of the audio signal to model a spectral suppression gain or filter that can be applied to the received audio signal in a time-frequency domain.

Wind noise is caused by turbulent airflow passing over the microphone. Wind noise consists of short local disturbances and, due to its non-stationary nature, cannot be attenuated using conventional noise reduction techniques. For example, noise cancellation using multichannel spatial filtering does not reduce wind noise because the wind noise is due to incoherence across the microphones. The presence of wind noise affects the performance of multi-channel processing, such as beamforming methods. Thus, there is a need for dedicated wind noise cancelation.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of audio signal enhancement for cancelling wind noise in an audio signal. The method includes receiving a plurality of audio signals via a plurality of microphones, respectively, of a microphone array, each of the plurality of audio signals representing a respective channel of a multi-channel audio signal and determining a coherence of audio signals from at least two microphones of the microphone array. The method further includes detecting a presence of wind noise in the multi-channel audio signal based on the coherence of the audio signals from the at least two microphones of the microphone array. The method further includes filtering the wind noise in an audio signal based on the coherence of the audio signals from the at least two microphones of the microphone array, and producing the audio signal with the wind noise cancelled.

Another innovative aspect of the subject matter of this disclosure can be implemented in an audio enhancement system configured for cancelling wind noise in an audio signal. The audio enhancement system includes a processing system and a memory storing instructions that, when executed by the processing system, causes the audio enhancement system to receive a plurality of audio signals via a plurality of microphones, respectively, of a microphone array, each of the plurality of audio signals representing a respective channel of a multi-channel audio signal. The audio enhancement system is further caused to determine a coherence of audio signals from at least two microphones of the microphone array and detect a presence of wind noise in the multi-channel audio signal based on the coherence of the audio signals from the at least two microphones of the microphone array. The audio enhancement system is further caused to filter the wind noise in an audio signal based on the coherence of the audio signals from the at least two microphones of the microphone array and produce the audio signal with the wind noise cancelled.

### BRIEF DESCRIPTION OF THE DRAWINGS

The present implementations are illustrated by way of example and are not intended to be limited by the figures of the accompanying drawings.

FIG. 1 shows an example audio receiver that supports wind cancellation in the audio signal.

FIG. 2 shows a block diagram of an example wind noise post filter, according to some implementations.

FIG. 3 shows a block diagram of an example wind noise detector, according to some implementations.

FIG. 4 shows a block diagram of an example wind noise filter that may be used in a wind noise post filter, according to some implementations.

FIG. 5 shows a block diagram of an example non-stationary noise gain component, according to some implementations.

FIG. 6 shows a block diagram of an example stationary noise gain component, according to some implementations.

FIG. 7 shows a block diagram of an example audio enhancement system, according to some implementations.

FIG. 8 shows an illustrative flowchart depicting an example operation for wind cancellation, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As discussed above, wind noise in audio signals may be caused by turbulent airflow that passes over a microphone. Wind noise may consist of short local disturbances and sustained disturbances, causing non-stationary and stationary noise in the audio signal. Due to the non-stationary nature of wind noise, convention noise reduction techniques cannot accurately attenuate wind noise.

Aspects of the present disclosure recognize the when wind noise is present, the energies of different microphones in a microphone array are uncorrelated, and accordingly uses the coherence of audio signals from at least two microphones to detect the presence of wind noise, and if detected, uses the coherence to filter the wind noise in the audio signals. Various aspects of the present disclosure generally relate to audio signal processing, and more particularly, to audio signal filtering techniques that can adapt to varying wind conditions. In some aspects, an audio enhancement system may include a wind noise post filter that includes a wind noise detector and a wind noise filter. Audio signals from a plurality of microphones in a microphone array may be received and the coherence of the audio signals may be determined. The wind noise detector may detect wind in the audio signals, for example, by determining if the coherence is less than a wind threshold. If no wind noise is detected, the wind noise filter may produce the audio signal without further processing, e.g., without filtering. On the other hand, if wind noise is detected, the wind noise filter may process the audio signal to cancel the wind noise from the audio signal. The filtering of the audio signal may be performed by determining a non-stationary noise gain that is based on the coherence of the audio signals. Additionally, the non-stationary noise gain may be used to generate a stationary noise gain. In some implementations, an auxiliary microphone, such as a bone conduction microphone or an internal microphone, which is configured to capture the energy of user speech, may be used to assist in determining the stationary noise gain. The wind noise filter may apply the non-stationary noise gain and the stationary noise to the audio signal to filter the wind noise in the audio signal. Particular implementations of the subject matter described in this present disclosure may be implemented to improve the quality of the audio signal by attenuating (e.g., cancelling) wind noise in the audio signal when wind noise is detected.

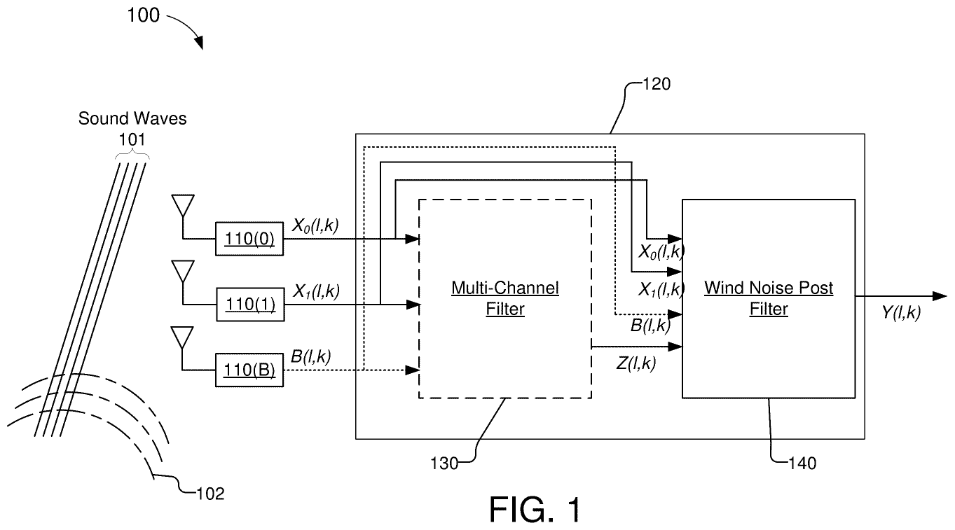

FIG. 1 shows an example audio receiver 100 that is configured for wind cancellation in the audio signal, as discussed herein. The audio receiver 100 includes a number of microphones 110(0) and 110(1), arranged in a microphone array, and a noise filter 120. While audio receiver 100 is illustrated with two microphones in the array, it should be understood that additional microphones may be included if desired. In some implementations, the audio receiver 100 may additionally include a bone conduction microphone 110(B).

The microphones 110(0) and 110(1) are configured to convert a series of sound waves 101 (also referred to as “acoustic waves”) into audio signals X₀ (l, k) and X₁ (l, k), respectively, where l is a frame index and k is a frequency index associated with a time-frequency domain. In some implementations, the sound waves 101 may include user speech and may be mixed with noise, such as caused by wind 102. The bone conduction microphone 110(B), if present, is better isolated from wind noise than any of the microphones of the microphone array and is configured to capture the energy of user speech, which is converted into audio signal B(l, k).

The noise filter 120 may include an optional multi-channel filter 130 and a wind noise post filter 140. The audio signals Xᵢ (l, k), i=0,1 and B(l, k), if the bone conduction microphone 110(B) is present, may be optionally processed by the multi-channel filter 130. The multi-channel filter 130, for example, may include any desired filter, such as a spatial filter, such as a beamformer, and may additionally or alternatively include nonlinear post filtering. The multi-channel filter 130, for example, receives the audio signals Xᵢ(l, k), i=0,1 and, optionally, B(l, k), and generates an output audio signal Z(l, k).

The wind noise post filter 140 receives the audio signal, Z(l,k), along with the audio signals from at least two microphones in the microphone array, e.g., Xᵢ(l, k), i=0,1 and, optionally, B(l, k). In an implementation in which the multi-channel filter 130 is not included in the noise filter 120, the audio signal Z(l, k) may be one of the audio signals from one of the microphones, e.g., Z(l, k)=X₀(l, k). The wind noise post filter 140 may include a wind noise detector to detect the presence of wind noise and a wind noise filter that processes the audio signal Z(l, k) if wind noise is detected and produces an enhanced audio signal (Y(l, k)).

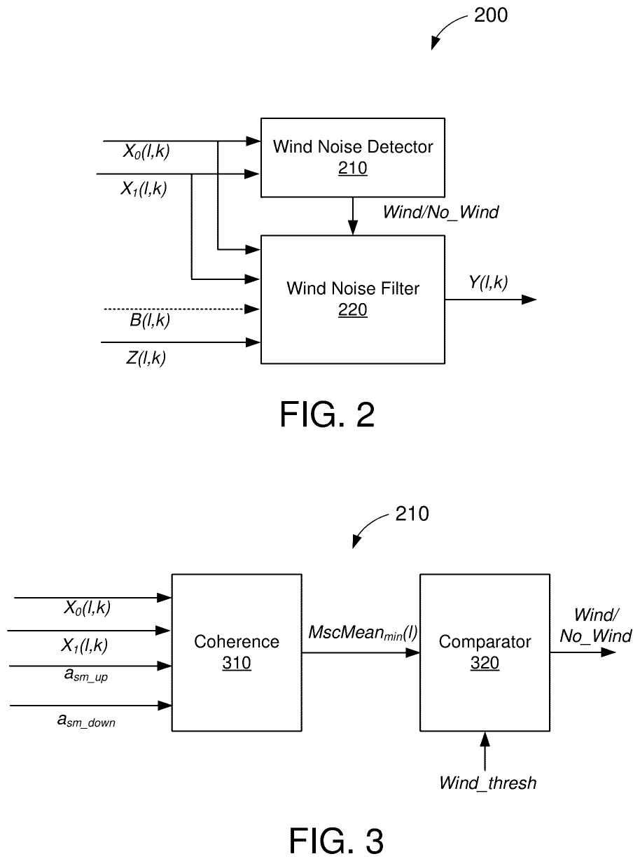

FIG. 2 shows a block diagram of an example wind noise post filter 200, according to some implementations. The wind noise post filter 200, for example, may be used as the wind noise post filter 140 illustrated in FIG. 1. When wind noise is present, the energies of the different microphones are uncorrelated, and accordingly, the wind noise post filter 200 uses the coherence of audio signals from at least two microphones, Xᵢ (l, k), i=0,1, to determine whether wind noise is present, and if so, to filter the wind noise from the audio signal Z(l,k). Accordingly, the wind noise post filter 200 may include a wind noise detector 210 and a wind noise filter 220.

As illustrated, wind noise post filter 200 includes a wind noise detector 210 that receives the audio signals from at least two microphones, Xᵢ(l, k), i=0,1, and is configured to detect the presence of wind noise in the audio signals. The wind noise detector 210 may determine whether wind noise is present based on the coherence of the audio signals Xᵢ (l, k), i=0,1. The wind noise detector 210 produces an output signal (Wind/No_Wind) indicating whether wind noise is detected in the audio signal.

The wind noise post filter 200 further includes a wind noise filter 220 that receives the audio signal, Z(l, k), along with the audio signals from at least the two microphones, e.g., Xᵢ(l, k), i=0,1 and, optionally, the signal from the bone conduction microphone B(l, k), and the output signal (Wind/No_Wind) from the wind noise detector 210. The audio signal, Z(l,k), for example, may be the output signal from a previous filter, e.g., the multi-channel filter 130 illustrated in FIG. 1, or may be the audio signals from one of the microphones, e.g., Z(l, k)=X₀(l, k), if a preceding filter is not used. The wind noise filter 220 processes the audio signal Z(l,k) to attenuate the wind noise, if wind noise is detected by the wind noise detector 210 (receives output signal (Wind) from wind noise detector 210), and produces the enhanced audio signal (Y(l, k)). The wind noise filter 220, for example, may filter the wind noise, based at least partially on the coherence of the audio signals X₀(l, k), i=0,1. If no wind noise is detected by the wind noise detector 210 (output signal (No_Wind) is received from wind noise detector 210), the wind noise filter 220 may not process the audio signal Z(l, k), and the resulting output signal (Y(l, k)) may be the audio signal Z(l,k), i.e., Y(l,k)=Z(l, k).

FIG. 3 shows a block diagram of an example wind noise detector 210, according to some implementations. In some aspects, the wind noise detector 210 may determine the coherence of the audio signals, Xᵢ(l, k), i=0,1, and may compare the coherence to a wind threshold to determine whether wind is present in the audio signals, and produce the output signal (Wind/No_Wind) in response. Accordingly, the wind noise detector 210 may include a coherence component 310 and a comparator 320.

The wind noise detector 210, for example, may include a coherence component 310 that is used to determine the coherence of audio signals from at least two microphones, e.g., audio signals Xᵢ(l, k), i=0,1. The coherence, for example, may be determined based on a magnitude squared coherence (MSC) of the audio signals. The magnitude squared coherence (MSC) of the audio signals used for wind noise detection may be determined as follows:

$$MSC ( l , k ) = \frac{{\vert {ϕ}_{1 , 2} ( l , k ) \vert}^{2}}{\vert {ϕ}_{1 , 1} ( l , k ) \vert \cdot \vert {ϕ}_{2 , 2} ( l , k ) \vert} \qquad eq . 1$$

$$where$$

$${ϕ}_{i , j} ( l , k ) = {α}_{s m} {ϕ}_{i , j} ( l - 1 , k ) + ( 1 - {α}_{s m} ) {X}_{i} ( l , k ) {X}_{j}^{*} ( l , k ) T \qquad eq . 2$$

where αₛₘ is a smoothing factor and X₀(l, k) is the raw frequency domain microphone signal at channel i, frequency bin k and frame l,

$${X}_{j}^{*}$$

indicates the conjugate of Xⱼ (l, k), and T is the transformation matrix. A modified normalized magnitude squared coherence MscMean(l) may be considered as follows:

$$MscMean ( l ) = min ( \frac{max ( MscXmagMean ( l ) , XmagFloor )}{max ( XmagMean ( l ) , XmagFloor )} , 1 ) , \qquad eq . 3$$

$$MscXmagMean ( l ) = {\sum }_{k = k 1}^{k 2} MSC ( l , k ) \vert {X}_{1} ( l , k ) \vert , \qquad eq . 4$$

$$XmagMean ( l ) = {\sum }_{k = k 1}^{k 2} \vert {X}_{1} ( l , k ) \vert , \qquad eq . 5$$

where k1:k2 is the frequency range of bins where wind noise is most likely to occur, which is usually between 1:800 Hz, and XmagFloor is to prevent detecting wind noise during weak windy situations.

The value of MscMean(l) may fluctuate significantly and a regular smoothing of this value will compromise the rapid detection of windy scenarios that is needed by the wind noise detector 210. Accordingly, the coherence component may use a minimum tracking of MscMean(l), which allows rapid detection in windy scenarios and, at the same time, smooths out the value to mitigate false positives and negatives occurrences. The minimal envelope tracking may be performed using a decreasing smoothing factor α_{sm_down} when the MscMean(l) value is decreasing so that MscMean(l) is smoothed less when MscMean(l) is decreasing to enable a relatively rapid movement down, and an increasing smoothing factor α_{sm_up} when the MscMean(l) value is increasing so that MscMean(l) is smoothed more when MscMean(l) is increased to enable a relatively slow movement up, as illustrated by the pseudo-code in Table 1. The increasing smoothing factor αₛₘ up is greater than the decreasing smoothing factor α_{sm_down}, and may be provided as parameters to the coherence component 310 along with the audio signals Xᵢ(l, k), i=0,1.

TABLE 1

```
if MscMeanₘᵢₙ(l − 1)< MscMean(l)
  MscMeanₘᵢₙ(l) = αₛₘ_{ᵤₚ}MscMeanₘᵢₙ(l − 1) +
      (1 − αₛₘ_{_{—}}ᵤₚ)MscMean(l)
else
  MscMeanₘᵢₙ(l) = αₛₘ_{_{—}}_{down}MscMeanₘᵢₙ(l − 1) +
    (1 − αₛₘ_{_{—}}_{down})MscMean(l)
end
```

The wind noise detector 210 may further include a comparator 320 that receives the coherence value, e.g., MscMeanₘᵢₙ (l), from the coherence component 310 and compares the coherence value to a wind threshold to determine if wind noise is present in the audio signal. When wind noise is present, the energies of the different microphones are uncorrelated and accordingly, the coherence value will be low. Accordingly, wind is detected when the coherence value is less than the wind threshold, e.g., MscMeanₘᵢₙ(l)<Wind_thresh, where Wind_thresh may be a scalar threshold that is provided as a parameter to the comparator 320.

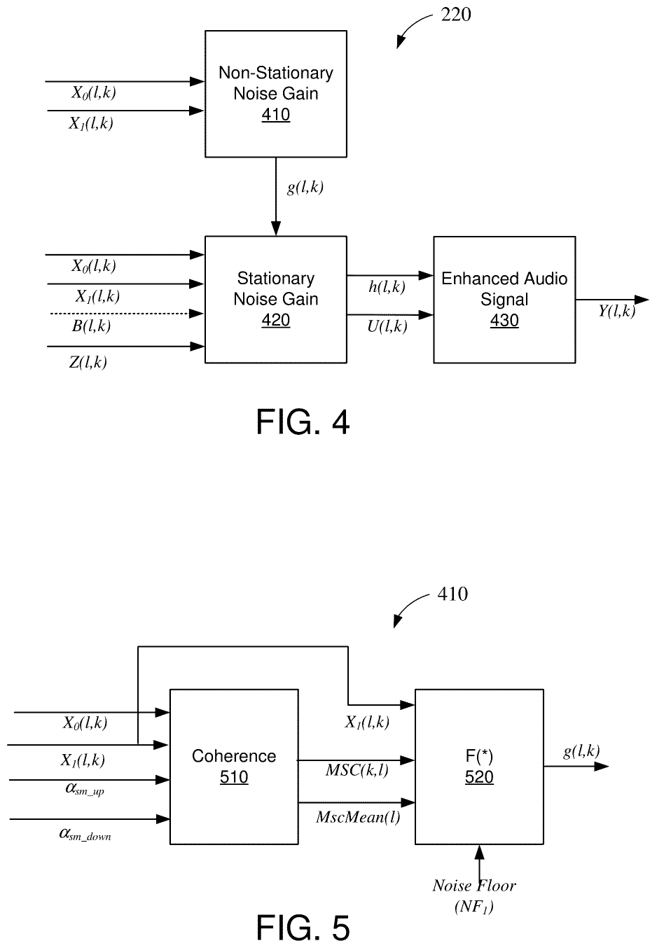

FIG. 4 shows a block diagram of an example wind noise filter 220 that may be used in the wind noise post filter 200 of FIG. 2, according to some implementations. In some aspects, the wind noise filter 220 generates the final output audio signal (Y(l, k)) based on a non-stationary noise gain, g(l, k), and a stationary noise gain, h(l, k), that are applied to the audio signal, Z(l, k), i.e.,

Y(l,k)=Z(l,k)g(l,k)h(l,k). eq. 6

Accordingly, the wind noise filter 220 may include a non-stationary noise gain component 410, a stationary noise gain component 420, and an enhanced audio signal component 430.

A non-stationary noise gain component 410 is used to generate the non-stationary noise gain g(l, k) based on the coherence of audio signals from at least two microphones, e.g., audio signals X₀(l, k), i=0,1.

A stationary noise gain component 420 is used to generate the stationary noise gain h(l, k) based on the non-stationary noise gain g(l, k) received from the non-stationary noise gain component 410. The stationary noise gain component 420 further receives the audio signal, Z(l, k), along with the audio signals from at least the two microphones, e.g., X₀(l, k), i=0,1 and, optionally, the signal from the bone conduction microphone B (l, k). The stationary noise gain component 420 may generate an intermediate processed output U(l, k) for the audio signal Z(l, k) based on the non-stationary noise gain g(l, k), in which the non-stationary noise is suppressed in the audio signal audio signal Z(l, k), and may be used to generate the stationary noise gain h(l, k). The intermediate processed output U(l, k), for example, may be determined as

U(l,k)=Z(l,k)g(l,k). eq. 7

The stationary noise gain component 420 may output the intermediate processed output U(l, k) and the stationary noise gain h(l, k).

An enhanced audio signal component 430 may receive the intermediate processed output U(l, k) and the stationary noise gain h(l, k) from the stationary noise gain component 420 and generates the final output audio signal (Y(l, k)) by applying the intermediate processed output U(l, k) and the stationary noise gain h(l, k).

FIG. 5 shows a block diagram of an example non-stationary noise gain component 410, according to some implementations. The non-stationary noise gain g(l, k) is a wind noise gain that is related to the coherence of audio signals from at least two microphones, e.g., audio signals Xᵢ(l, k), i=0,1. The non-stationary noise gain g(l, k) should be lower for frequencies in which there is less coherence. Thus, the non-stationary noise gain g(l, k) may be a function of the magnitude squared coherence MSC(l, k), as well as the normalized magnitude squared coherence MscMean(l), and the raw audio signal from one of the microphones, e.g., X₁(l, k).

g(l,k)=F(MSC(l,k),MscMean(l),X₁(l,k)) eq. 8

The non-stationary noise gain component 410, accordingly, may include a coherence component 510 that is used to determine the coherence of audio signals from at least two microphones, e.g., audio signals Xᵢ(l, k), i=0,1, similar to the coherence component 310 used in the wind noise detector 210, discussed in reference to FIG. 3. In some implementations, the same coherence component may be used for the non-stationary noise gain component 410 and the wind noise detector 210. The coherence component 510 may receive the audio signals Xᵢ(l, k), i=0,1, and smoothing factors α_{sm_up} and α_{sm_down}, and as discussed above, may determine the magnitude squared coherence MSC(l, k) as discussed in reference to equations 1 and 2, and the normalized magnitude squared coherence MscMean(l) as discussed in reference to equations 3, 4, and 5.

As noted above, the non-stationary noise gain g(l, k) may be a function of the magnitude squared coherence MSC(l, k), the normalized magnitude squared coherence MscMean(l), and the raw audio signal from one of the microphones, e.g., X₁(l, k). The non-stationary noise gain component 410, accordingly, may further include a function (F(*)) component 520 that receives these parameters and relates MSC(l, k) values to a single probability gain to reduce the effect of noise. In some implementations, the function applied by function (F(*)) component 520 may be modeled by a data driven approach where F(*) is a Neural Network Model with the inputs MSC(l, k), MscMean(l), X₁(l, k) and output a single gain g(l, k) to produce the probability. In some implementations, the function applied by function (F(*)) component 520 may be a simple deterministic function, one example of which is:

g(l,k)=max(MSC(l,k)−MscMean(l),NF₁) eq. 9

The noise floor parameter NF₁ is a tuning parameter received by the function (F(*)) component 520 and is used to set the floor of the non-stationary noise gain g(l, k) and to prevent the gain from being negative.

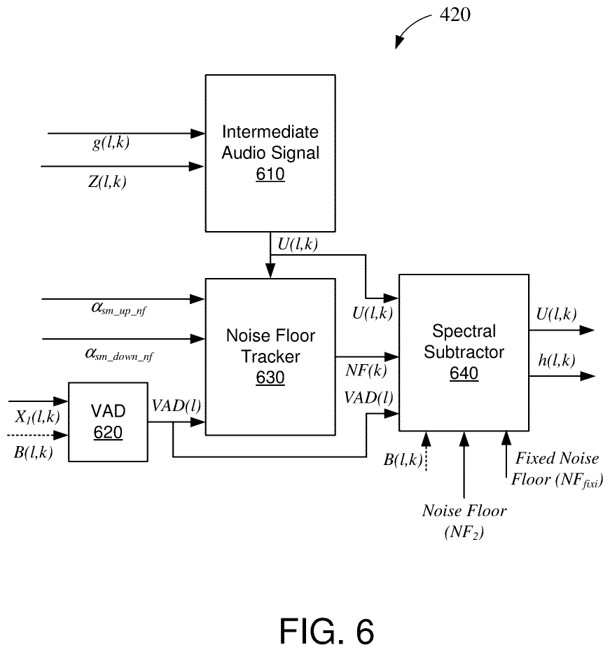

FIG. 6 shows a block diagram of an example stationary noise gain component 420 to determine the stationary noise gain h(l, k) based on the non-stationary noise gain g(l, k), according to some implementations. The stationary noise gain component 420 includes an intermediate audio signal component 610, a voice activity detector (VAD) 620, a noise floor tracker 630, and a spectral subtractor 640.

The stationary noise gain component 420 includes an intermediate audio signal component 610 to generate an intermediate processed output U(l, k) based on the audio signal Z(l, k), and the non-stationary noise gain g(l, k) received from the non-stationary noise gain component 410. The intermediate processed output U(l, k) may be obtained as

U(l,k)=Z(l,k)g(l,k). eq. 10

The next step is to track the noise floor of the intermediate processed output U(l, k) for all the frequency bins that may include speech, e.g., bins that are supervised by voice activity detection.

A VAD 620 is configured to determine or predict whether speech is present (or absent) within specific frequency bins in the audio signal X₁(l, k). More specifically, the VAD 620 produces a VAD parameter (VAD(l)) indicating whether speech is present or absent in the current frame l of the audio signal X₁(l, k). In some implementations, the VAD 620 may include a neural network model, e.g., a deep neural network (DNN), that is trained to infer a probability of speech (P_{DNN}(l, k)) in the audio signal X₁(l, k), and the VAD 620 may generate the VAD parameter VAD(l) based on the probability of speech P_{DNN} (l, k). For example, the VAD 620 may determine that speech is present in the audio signal X₁(l, k) (VAD(l)=1) if the probability of speech P_{DNN}(l, k), averaged across all supervised frequency bins k, is greater than a threshold probability.

In some other implementations, the VAD 620 may generate the VAD parameter VAD(l) based on the energy detected in an auxiliary audio signal (such as the optional auxiliary signal B(l, k)) received via the bone microphone 110(B) in FIG. 1). As described with reference to FIG. 1, some auxiliary microphones (such as bone conduction microphone 110(B)) are configured to only capture the energy of user speech. In other words, background noise or wind noise may not be present or otherwise reflected in the auxiliary audio signals. Thus, aspects of the present disclosure recognize that the energy in the auxiliary audio signal may directly indicate a presence or absence of speech. For example, the VAD 620 may determine that speech is present in the audio signal X₁(l, k) (VAD(l)=1) if the energy of the auxiliary audio signal B(l, k)) is greater than a threshold energy level.

The noise floor tracker 630 receives indication of whether the audio signal may include speech in the VAD parameter VAD(l) and tracks the noise floor NF(l, k) of the intermediate processed output U(l, k) for all the frequency bins that may include speech as illustrated by the pseudo-code in Table 2. The noise floor is smoothed with up and down smoothing factors, α_{sm_up_nf} and α_{sm_down_nf}, respectively, which may be received as parameters by the noise floor tracker 630. As illustrated in the pseudo-code in Table 2, the noise floor NF(l, k) is only updated when there is no speech.

```
TABLE 2
if VAD==0 (i.e., there is no speech)
  for k=1:end
    if NF(l − 1, k) < |U(l, k)|
      NF(l, k) = αₛₘ_{_{—}}ᵤₚ_{_{—}}_{nf} * NF (l − 1, k) + (1 − αₛₘ_{_{—}}ᵤₚ_{_{—}}_{nf}) * |U(l, k)|
    else
      NF(l, k) = αₛₘ_{_{—}}_{down}_{_{—}}_{nf} * NF (l − 1, k) + (1 − αₛₘ_{_{—}}_{down}_{_{—}}_{nf}) * |U(l, k)|
    end
  end
end
```

Once the noise floor NF(l, k) is estimated for every frequency bin, spectral subtractor 640 may use the intermediate processed output U(l, k) and the noise floor NF(l, k) to generate the stationary noise gain h(l, k). In some implementations, the spectral subtraction by spectral subtractor 640 may be supervised by VAD 620 and the VAD parameter VAD(l) indicating whether speech is present in the audio signal. For example, while speech is present, the stationary noise gain h(l, k) may be generated by subtracting a factor of the noise floor NF(l, k), which was determined during a preceding frame without speech, from the intermediate processed output U(l, k), wherein the factor of the noise floor NF(l, k) is determined based on a noise over-estimate parameters β. On the other hand, while speech is not present, the stationary noise gain h(l, k) may simply be the fixed noise floor value NF_{fix}. By way of example, one implementation of determining the stationary noise gain h(l, k) is illustrated by the pseudo-code in Table 3, where the noise over-estimate parameter β is used to determine the factor of the noise floor NF(l, k) and the fixed noise floor minimum NF_{fix} parameter are received by the spectral subtractor 640.

TABLE 3

```
If VAD # 0 (i.e., there is speech)
    $h ( l , k ) = max ( \frac{\vert U ( l , k ) \vert - β NF ( l , k )}{\vert U ( l , k ) \vert} , {NF}_{fix} )$
else
    h(l, k) = NF_{fix}
end
```

In some implementations, the auxiliary signal B(l, k) received via the bone conduction microphone 110(B) shown in FIG. 1 may additionally be used by the spectral subtractor 640 to generate the stationary noise gain h(l, k). By way of example, in one implementation, illustrated by the pseudo-code in Table 4, the intermediate processed output U(l, k) may be replaced by the bone conduction microphone signal B (l, k) and a calibrated bone microphone equalization weight parameter bone_bin_EQ(1:k_{c}) may be used for frequencies up to the cut-off frequency k_{c}, of the bone conduction microphone, and different fixed noise floor minimum parameters NF_{fix1} and NF_{fix2} may be received and used by the spectral subtractor 640.

TABLE 4
if VAD ≠ 0 (i.e., there is speech)
$h ( l , 1 : {k}_{c} ) = bone\_bin \_EQ ( 1 : {k}_{c} ) * max ( \frac{\vert B ( l , 1 : {k}_{c} ) \vert - β NF ( l , 1 : {k}_{c} )}{\vert B ( l , 1 : {k}_{c} ) \vert} , {NF}_{fix 1} )$ $h ( l , {k}_{c} + 1 : end ) = max ( \frac{\vert U ( l , {k}_{c} + 1 : end ) \vert - β NF ( l , {k}_{c} + 1 : end )}{\vert U ( l , {k}_{c} + 1 : end ) \vert} , {NF}_{fix 2} )$
else
h(1: k_{c}) = NF_{fix1}
h(k_{c} + 1: end) = NF_{fix2}
end

The spectral subtractor 640 outputs the stationary noise gain h(l, k) as well as the intermediate processed output U(l, k), or equivalently, the non-stationary noise gain g(l, k) and the audio signal Z(l, k). As illustrated in, FIG. 4, the enhanced audio signal component 430 may then multiply the stationary noise gain h(l, k) and the intermediate processed output U(l, k), to generate the final output audio signal Y(l, k) of the wind noise filter 220 (shown in FIG. 2) when wind noise is detected by the wind noise detector 210.

Y(l,k)=h(l,k)*U(l,k) eq. 11

When no wind noise is detected by the wind noise detector 210, the final output audio signal Y(l, k) of the wind noise filter 220, is the audio signal Z(l,k).

Y(l,k)=Z(l,k) eq. 12

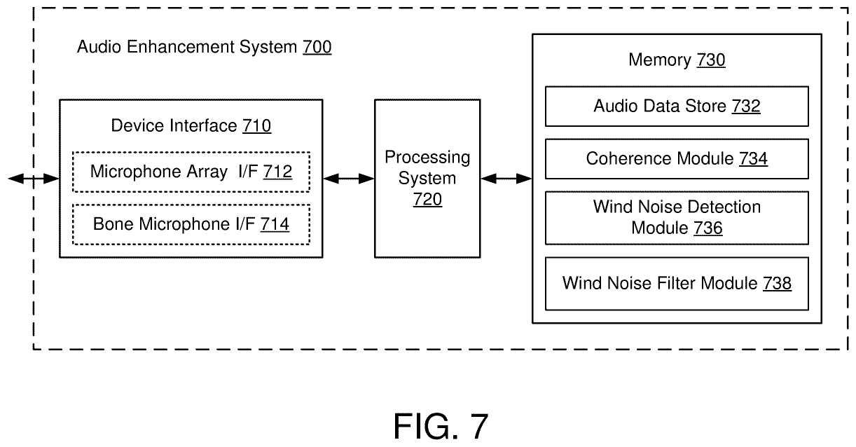

FIG. 7 shows another block diagram of an example audio enhancement system 700, according to some implementations. The audio enhancement system 700 is configured to enhance an audio signal by detecting and cancelling wind noise when present in a multi-channel audio signal based, at least in part, on the coherence of audio signals from at least two microphones, as discussed herein. The multi-channel audio signal may be received via a microphone array that includes the at least two microphones. In some implementations, an auxiliary audio signal may be received via an auxiliary microphone that is separate from the microphone array. In some implementations, the microphone array may be microphones 110(0) and 110(1) of FIG. 1 and the auxiliary microphone may be one example of the bone conduction microphone 110(B) of FIG. 1.

The audio enhancement system 700 includes a device interface 710, a processing system 720, and a memory 730. The device interface 710 is configured to communicate with one or more components of an audio receiver (such as the audio receiver 100 of FIG. 1). In some implementations, the device interface 710 may include a microphone array interface (I/F) 712 configured to communicate with the microphone array and an auxiliary microphone interface (I/F) 714 configured to communicate with the auxiliary microphone. The microphone array interface 712 may receive a plurality of audio signals via a plurality of microphones, respectively, of the microphone array, where each audio signal of the plurality of audio signals represents a respective channel of the multi-channel audio signal. The auxiliary microphone interface 714 may receive the auxiliary audio signal via the auxiliary microphone.

The memory 730 may include an audio data store 732 configured to store frames of the multi-channel audio signal and the auxiliary audio signal as well as any intermediate signals that may be produced by the audio enhancement system 700 as a result of audio enhancement. The memory 730 also may include a non-transitory computer-readable medium (including one or more nonvolatile memory elements, such as EPROM, EEPROM, Flash memory, or a hard drive, among other examples) that may store at least the following software (SW) modules:
a coherence SW module 734 to detect the coherence of at least two audio signals received via the microphone array interface 712;
a wind noise detection SW module 736 to detect wind noise in the audio signals based on the coherence of the audio signals; and
a wind noise filter SW module 738 to filter the wind noise in the audio signal based on the coherence of the audio signals and, optionally, based on the auxiliary signal received via the auxiliary microphone interface 714 when wind noise is detected in the audio signals.

Each software module includes instructions that, when executed by the processing system 720, causes the audio enhancement system 700 to perform the corresponding functions.

The processing system 720 may include any suitable one or more processors capable of executing scripts or instructions of one or more software programs stored in the audio enhancement system 700 (such as in the memory 730). For example, the processing system 720 may execute the coherence SW module 734 to detect the coherence of at least two audio signals received via the microphone array interface 712. The processing system 720 also may execute the wind noise detection SW module 736 to detect wind noise in the audio signals based on the coherence of the audio signals. Further, the processing system 720 may execute the wind noise filter SW module 738 to filter the wind noise in the audio signal based on the coherence of the audio signals and, optionally, based on the auxiliary signal received via the auxiliary microphone interface 714 when wind noise is detected in the audio signals.

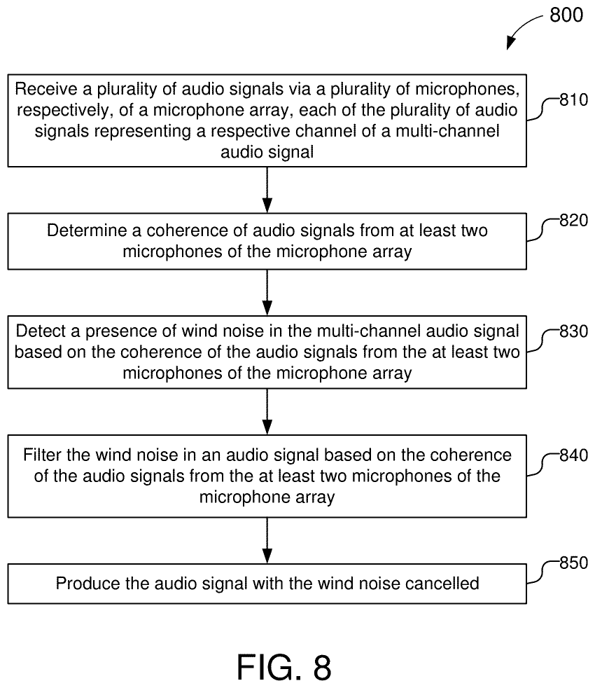

FIG. 8 shows an illustrative flowchart depicting an example operation 800 for audio enhancement by detecting and cancelling wind noise in an audio signal, according to some implementations. In some implementations, the example operation 800 may be performed by an audio enhancement system such as the audio receiver 100 of FIG. 1, the wind noise post filter 200 of FIG. 2, or the audio enhancement system 700 of FIG. 7.

The audio enhancement system receives a plurality of audio signals via a plurality of microphones, respectively, of a microphone array, each of the plurality of audio signals representing a respective channel of a multi-channel audio signal (810), e.g., as illustrated by audio signals Xᵢ(l, k), i=0,1, from microphones 110(0) and 110(1) and the audio signal B(l, k) from bone conduction microphone 110(B), received by the wind noise post filter 140 and 200 shown in FIGS. 1 and 2, respectively.

The audio enhancement system determines a coherence of audio signals from at least two microphones of the microphone array (820), e.g., as illustrated by the coherence components 310 and 510 shown in FIGS. 3 and 5, respectively. In some implementations, the audio enhancement system may determine the coherence of audio signals from at least two microphones of the microphone array based on a magnitude squared coherence of the audio signals from the at least two microphones, e.g., as illustrated and discussed in relation to the coherence components 310 and 510 shown in FIGS. 3 and 5, respectively. The magnitude squared coherence of the audio signals from the plurality of microphones may be determined over a range of frequencies, and may be determined using a first smoothing factor when the magnitude squared coherence is decreasing and a second smoothing factor when the magnitude squared coherence is increasing, wherein the first smoothing factor produces a faster rate of change in the magnitude squared coherence than the second smoothing factor, e.g., as illustrated and discussed in relation to the coherence components 310 and 510 and smoothing factors αₛₘ_down and αₛₘ up in FIGS. 3 and 5, and TABLE 1.

The audio enhancement system detects a presence of wind noise in the multi-channel audio signal based on the coherence of the audio signals from the at least two microphones of the microphone array (830), e.g., as illustrated by wind noise detector 210 in FIGS. 2 and 3. In some implementations, the audio enhancement system may detect the presence of wind noise by determining the coherence of the audio signals is less than a wind threshold, e.g., as illustrated and discussed in relation to wind noise detector 210 and comparator 320 in FIGS. 2 and 3.

The audio enhancement system filters the wind noise in an audio signal based on the coherence of the audio signals from the at least two microphones of the microphone array (840), e.g., as illustrated by the wind noise filter 220 filtering audio signal audio signal Z(l,k) in FIGS. 2 and 4.

The audio enhancement system produces the audio signal with the wind noise cancelled (850), e.g., as illustrated by final output signal Y(l, k) produced the wind noise post filters 140 and 200 shown in FIGS. 1 and 2, respectively.

In some implementations, the audio enhancement system may further apply a multi-channel filter to the multi-channel audio signal to produce the audio signal before detecting the presence of wind noise and filtering the wind noise in the audio signal, e.g., as illustrated by the multi-channel filter 130 producing the audio signal Z(l,k) shown in FIG. 1.

In some implementations, the audio enhancement system may filter the wind noise in the audio signal by determining a non-stationary noise gain based on the coherence of the audio signals from the at least two microphones of the microphone array, e.g. as illustrated and discussed in relation to the wind noise filter 220 and non-stationary noise gain component 410 in FIGS. 2 and 4. The audio enhancement system may further determine a stationary noise gain based on the non-stationary noise gain, e.g., as illustrated and discussed in relation to the wind noise filter 220 and stationary noise gain component 420 in FIGS. 2 and 4. Further, the audio enhancement system may apply the non-stationary noise gain and the stationary noise gain to the audio signal, e.g., as illustrated and discussed in relation to the wind noise filter 220, stationary noise gain component 420 and enhanced audio signal component 430 in FIGS. 2 and 4.

For example, in some implementations, the audio enhancement system may determine the non-stationary noise gain by determining a magnitude squared coherence with respect to frequency for the audio signals from the at least two microphones, determining a normalized magnitude squared coherence for a range of frequencies for the audio signals from the at least two microphones based on the magnitude squared coherence with respect to frequency, where the non-stationary noise gain is determined based at least on the magnitude squared coherence and the normalized magnitude squared coherence, e.g. as illustrated and discussed in relation to non-stationary noise gain component 410 shown in FIGS. 4 and 5 and the coherence component 510 and function (F(*)) component 520 shown in FIG. 5. For example, in some implementations, the audio enhancement system may determine the non-stationary noise gain further based on at least one of an audio signal from at least one microphone and a noise floor, e.g., as illustrated and discussed in relation to non-stationary noise gain component 410 shown in FIGS. 4 and 5 and the function (F(*)) component 520 shown in FIG. 5. The non-stationary noise gain may be determined based on a deterministic function or a neural network model, e.g., as discussed in relation to non-stationary noise gain component 410 shown in FIGS. 4 and 5, the function (F(*)) component 520 shown in FIG. 5, and equation 9.

For example, in some implementations, the audio enhancement system may determine the stationary noise gain based on the non-stationary noise gain by applying the non-stationary noise gain to the audio signal to generate an intermediate audio signal with non-stationary noise suppressed, tracking a noise floor with respect to frequency of the intermediate audio signal when there is no speech in the audio signal determined by voice activation detection, and determining the stationary noise gain when there is speech in the audio signal based on a difference between the intermediate audio signal and the noise floor tracked when there is no speech in the audio signal determined by the voice activation detection, e.g. as illustrated and discussed in relation to stationary noise gain component 420 shown in FIGS. 4 and 6 and TABLES 2, 3, and 4. For example, in some implementations, the audio enhancement system may track the noise floor with respect to frequency of the intermediate audio signal when there is no speech in the audio signal by applying a first smoothing factor that increases the noise floor when the noise floor is less than the intermediate audio signal and applying a second smoothing factor that decreases the noise floor when the noise floor is greater than the intermediate audio signal, e.g. as illustrated and discussed in relation to stationary noise gain component 420, noise floor tracker 630, and smoothing factors α_{sm_up_nf} and α_{sm_down_nf} shown in FIGS. 4 and 6 and TABLE 2. In some implementations, one of the microphones may be a bone conduction microphone that monitors a range of frequencies, and the audio enhancement system may determine the stationary noise gain when there is no speech by determining the stationary noise gain for the range of frequencies monitored by the bone conduction microphone based on a difference between a signal from the bone conduction microphone and the noise floor tracked when there is no speech in the audio signal, and determining the stationary noise gain for frequencies not monitored by the bone conduction microphone based on the difference between the intermediate audio signal and the noise floor tracked when there is no speech in the audio signal, e.g. as illustrated and discussed in relation to stationary noise gain component 420 shown in FIGS. 4 and 6 and TABLE 4. In some implementations, the stationary noise gain may include a fixed noise floor when there is no speech in the audio signal determined by the voice activation detection, e.g., as illustrated and discussed in relation to stationary noise gain component 420 shown in FIGS. 4 and 6 and TABLES 3 and 4.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of cancelling wind noise in an audio signal, comprising:
receiving a plurality of audio signals via a plurality of microphones, respectively, of a microphone array, each of the plurality of audio signals representing a respective channel of a multi-channel audio signal;
determining a coherence of audio signals from at least two microphones of the microphone array;
detecting a presence of wind noise in the multi-channel audio signal based on the coherence of the audio signals from the at least two microphones of the microphone array;
filtering the wind noise in an audio signal based on the coherence of the audio signals from the at least two microphones of the microphone array; and
producing the audio signal with the wind noise cancelled.

2. The method of claim 1, further comprising applying a multi-channel filter to the multi-channel audio signal to produce the audio signal before detecting the presence of wind noise and filtering the wind noise in the audio signal.

3. The method of claim 1, wherein determining the coherence of audio signals from at least two microphones of the microphone array is based on a magnitude squared coherence of the audio signals from the at least two microphones.

4. The method of claim 3, wherein the magnitude squared coherence of the audio signals from the plurality of microphones is determined over a range of frequencies, and is determined using a first smoothing factor when the magnitude squared coherence is decreasing and a second smoothing factor when the magnitude squared coherence is increasing, wherein the first smoothing factor produces a faster rate of change in the magnitude squared coherence than the second smoothing factor.

5. The method of claim 1, wherein detecting the presence of wind noise comprises determining the coherence of the audio signals is less than a wind threshold.

6. The method of claim 1, wherein filtering the wind noise in the audio signal comprises:
determining a non-stationary noise gain based on the coherence of the audio signals from the at least two microphones of the microphone array;
determining a stationary noise gain based on the non-stationary noise gain; and
applying the non-stationary noise gain and the stationary noise gain to the audio signal.

7. The method of claim 6, wherein determining the non-stationary noise gain comprises:
determining a magnitude squared coherence with respect to frequency for the audio signals from the at least two microphones; and
determining a normalized magnitude squared coherence for a range of frequencies for the audio signals from the at least two microphones based on the magnitude squared coherence with respect to frequency;
wherein determining the non-stationary noise gain is based at least on the magnitude squared coherence and the normalized magnitude squared coherence.

8. The method of claim 7, wherein determining the non-stationary noise gain is further based on at least one of an audio signal from at least one microphone and a noise floor.

9. The method of claim 7, wherein determining the non-stationary noise gain is based on a deterministic function or a neural network model.

10. The method of claim 6, wherein determining the stationary noise gain based on the non-stationary noise gain comprises:
applying the non-stationary noise gain to the audio signal to generate an intermediate audio signal with non-stationary noise suppressed;
tracking a noise floor with respect to frequency of the intermediate audio signal when there is no speech in the audio signal determined by voice activation detection; and
determining the stationary noise gain when there is speech in the audio signal based on a difference between the intermediate audio signal and the noise floor tracked when there is no speech in the audio signal determined by the voice activation detection.

11. The method of claim 10, wherein tracking the noise floor with respect to frequency of the intermediate audio signal when there is no speech in the audio signal comprises applying a first smoothing factor that increases the noise floor when the noise floor is less than the intermediate audio signal and applying a second smoothing factor that decreases the noise floor when the noise floor is greater than the intermediate audio signal.

12. The method of claim 10, wherein one of the microphones is a bone conduction microphone that monitors a range of frequencies, wherein determining the stationary noise gain when there is no speech comprises:
determining the stationary noise gain for the range of frequencies monitored by the bone conduction microphone based on a difference between a signal from the bone conduction microphone and the noise floor tracked when there is no speech in the audio signal; and
determining the stationary noise gain for frequencies not monitored by the bone conduction microphone based on the difference between the intermediate audio signal and the noise floor tracked when there is no speech in the audio signal.

13. The method of claim 10, wherein the stationary noise gain comprises a fixed noise floor when there is no speech in the audio signal determined by the voice activation detection.

14. An audio enhancement system configured for cancelling wind noise in an audio signal, comprising:
a processing system; and
a memory storing instructions that, when executed by the processing system, causes the audio enhancement system to:
receive a plurality of audio signals via a plurality of microphones, respectively, of a microphone array, each of the plurality of audio signals representing a respective channel of a multi-channel audio signal;
determine a coherence of audio signals from at least two microphones of the microphone array;
detect a presence of wind noise in the multi-channel audio signal based on the coherence of the audio signals from the at least two microphones of the microphone array;
filter the wind noise in an audio signal based on the coherence of the audio signals from the at least two microphones of the microphone array; and
produce the audio signal with the wind noise cancelled.

15. The audio enhancement system of claim 14, wherein the audio enhancement system is further caused to apply a multi-channel filter to the multi-channel audio signal to produce the audio signal before detecting the presence of wind noise and filtering the wind noise in the audio signal.

16. The audio enhancement system of claim 14, wherein the audio enhancement system determines the coherence of audio signals from at least two microphones of the microphone array based on a magnitude squared coherence of the audio signals from the at least two microphones.

17. The audio enhancement system of claim 16, wherein the magnitude squared coherence of the audio signals from the plurality of microphones is determined over a range of frequencies, and is determined using a first smoothing factor when the magnitude squared coherence is decreasing and a second smoothing factor when the magnitude squared coherence is increasing, wherein the first smoothing factor produces a faster rate of change in the magnitude squared coherence than the second smoothing factor.

18. The audio enhancement system of claim 14, wherein the audio enhancement system detects the presence of wind noise by being caused to determine the coherence of the audio signals is less than a wind threshold.

19. The audio enhancement system of claim 14, wherein the audio enhancement system filters the wind noise in the audio signal by being cause to:
determine a non-stationary noise gain based on the coherence of the audio signals from the at least two microphones of the microphone array;
determine a stationary noise gain based on the non-stationary noise gain; and
apply the non-stationary noise gain and the stationary noise gain to the audio signal.

20. The audio enhancement system of claim 19, wherein the audio enhancement system determines the non-stationary noise gain by being caused to:
determine a magnitude squared coherence with respect to frequency for the audio signals from the at least two microphones; and
determine a normalized magnitude squared coherence for a range of frequencies for the audio signals from the at least two microphones based on the magnitude squared coherence with respect to frequency;
wherein the audio enhancement system determines the non-stationary noise gain based at least on the magnitude squared coherence and the normalized magnitude squared coherence.

21. The audio enhancement system of claim 20, wherein the audio enhancement system determines the non-stationary noise gain further based on at least one of an audio signal from at least one microphone and a noise floor.

22. The audio enhancement system of claim 20, wherein the audio enhancement system determines the non-stationary noise gain based on a deterministic function or a neural network model.

23. The audio enhancement system of claim 19, wherein the audio enhancement system determines the stationary noise gain based on the non-stationary noise gain by being caused to:
apply the non-stationary noise gain to the audio signal to generate an intermediate audio signal with non-stationary noise suppressed;
track a noise floor with respect to frequency of the intermediate audio signal when there is no speech in the audio signal determined by voice activation detection; and
determine the stationary noise gain when there is speech in the audio signal based on a difference between the intermediate audio signal and the noise floor tracked when there is no speech in the audio signal determined by the voice activation detection.

24. The audio enhancement system of claim 23, wherein the audio enhancement system tracks the noise floor with respect to frequency of the intermediate audio signal when there is no speech in the audio signal by being caused to apply a first smoothing factor that increases the noise floor when the noise floor is less than the intermediate audio signal and apply a second smoothing factor that decreases the noise floor when the noise floor is greater than the intermediate audio signal.

25. The audio enhancement system of claim 23, wherein one of the microphones is a bone conduction microphone that monitors a range of frequencies, wherein the audio enhancement system determines the stationary noise gain when there is no speech by being caused to:
determine the stationary noise gain for the range of frequencies monitored by the bone conduction microphone based on a difference between a signal from the bone conduction microphone and the noise floor tracked when there is no speech in the audio signal; and
determine the stationary noise gain for frequencies not monitored by the bone conduction microphone based on the difference between the intermediate audio signal and the noise floor tracked when there is no speech in the audio signal.

26. The audio enhancement system of claim 23, wherein the stationary noise gain comprises a fixed noise floor when there is no speech in the audio signal determined by the voice activation detection.
